(19) United States
(12) Patent Application Publication
(10) Pub. No.: US 2007/0110280 A1
(43) Pub. Date: May 17, 2007

(54) Methods for Determining Coating Thickness of a Prosthesis

(76) Inventors: Lisa M. Weldon, Mountain View, CA (US); Ellen Roche, Galway (IE); Eoin Banville, Galway (IE)

Correspondence Address: ROBERT DEBERARDINE;ABBOTT LABORATORIES, 100 ABBOTT PARK ROAD, DEPT. 377/AP6A, ABBOTT PARK, IL, 60064-6008, US

(21) Appl. No.: 11/464,436

(22) Filed: Aug. 14, 2006

Related U.S. Application Data
(60) Provisional application No. 60/731,069, filed on Oct. 28, 2005.
(60) Provisional application No. 60/831,395, filed on Jul. 17, 2006.

(51) Int. Cl. G06K 9/00

(52) U.S. Cl. 382/108

(57) ABSTRACT

A method for determining the thickness of a coating or a plurality of coatings applied to medical devices. In particular, determining coating thickness of a medical device including an endoprosthesis.

### CROSS-REFERENCE TO RELATED APPLICATIONS

This is an application which claims benefit of, provisional application Ser. No. 60/731,069 filed on Oct. 28, 2005, and provisional application Ser. No. 60/831,395 filed on Jul. 7, 2006, whereby the entire disclosures of which are incorporated herein by reference.

### FIELD OF THE INVENTION

The invention relates to a method for determining the thickness of coatings applied to a prosthesis, more specifically, methods and processes for determining the thickness of one or more coatings disposed on a prosthesis, wherein embodiments include coating(s) having varied concentrations of beneficial agent along the prosthesis length.

### BACKGROUND OF THE INVENTION

Percutaneous transluminal coronary angioplasty (PTCA) is a procedure for treating heart disease. This procedure generally entails introducing a catheter assembly into the cardiovascular system of a patient via the brachial or femoral artery, and advancing the catheter assembly through the coronary vasculature until a balloon portion thereon is positioned across an occlusive lesion. Once in position across the lesion, the balloon is inflated to a predetermined size to radially compress against the atherosclerotic plaque of the lesion to remodel the vessel wall. Subsequently, the balloon is deflated to allow the catheter assembly to be withdrawn from the vasculature.

While PCTA is widely used, it suffers from two unique problems. First, the blood vessel may suffer acute occlusion immediately after or within the initial hours after the dilation procedure. Such occlusion is referred to as “abrupt closure.” Abrupt closure occurs in approximately five percent of cases in which PTCA is employed. The primary mechanisms of abrupt closures are believed to be elastic recoil, arterial dissection and/or thrombosis. The second problem associated with this procedure is the re-narrowing of an artery after an initially successful angioplasty. This re-narrowing is referred to as “restenosis,” which typically occurs within the first six months after angioplasty. Restenosis is believed to be due to, among other things, the proliferation and migration of cellular components from the arterial wall, as well as through geometric changes in the arterial wall referred to as “remodeling.”

To reduce occlusion of the artery, and the development of thrombosis and/or restenosis, an expandable interventional device or prosthesis, one example of which includes a stent, is implanted in the lumen to maintain the vascular patency. Additionally, to better effectuate the treatment of such vascular disease, it is an embodiment of the invention to load an intraluminal device or prosthesis with one or more beneficial agents, including antiproliferatives, for delivery to a lumen. One commonly applied technique for the local delivery of a drug is through the use of a polymeric carrier coated onto the surface of a stent, as disclosed in Berg et al., U.S. Pat. No. 5,464,650, the disclosure of which is incorporated herein by reference. Such conventional methods and products generally have been considered satisfactory for their intended purpose. However, some problems associated with such drug eluting interventional devices is the variability in drug loading across an interventional device, as well as the variability in drug concentration from device to device. Other disadvantages include the inability to tightly control and maintain drug concentration, the inability to verify drug distribution or drug loading on any given device, the inability to vary drug distribution in a controlled and predetermined manner to effect a more desirable drug loading profile, the inability to load different, and in particular incompatible or reactive drugs onto the same surface of a device, and the difficulty in controlling the local areal density of beneficial agent that is delivered to the lumen, particularly if the interventional device is an overlapping or bifurcated device coated with beneficial agent.

As evident from the related art, conventional methods of loading interventional devices with beneficial agents, including drugs, often requires coating the entire prosthesis with a polymer capable of releasing therapeutic drugs, as disclosed in Campbell, U.S. Pat. No. 5,649,977 and Dinh et al., U.S. Pat. No. 5,591,227, the disclosures of which are incorporated herein by reference. Because certain interventional devices may a have varied surface area along its length, such conventional loading techniques results in unintentional or undesirable dosage variations. Additionally, if it is desired to superimpose two or more conventionally-loaded prostheses, including with nested stents or bifurcated stents, the total dosage of beneficial agent to the lumen will exceed the nominal or desired dosage. Another drawback of the conventional methods of loading interventional devices with beneficial agents is the lack of selective dosing, including providing various beneficial agents or various concentrations of the same beneficial agent at different locations on a prosthesis to effect a therapy at specific targeted sites.

After coating a prosthesis with a beneficial agent and/or other coatings it is desirable to determine the volume of beneficial agent which has been disposed on the prosthesis. Current methods of determining the amount of beneficial agent and/or other coatings disposed on the prosthesis require that the prosthesis is weighed before and after the coating process, wherein the difference in weight is the amount of coating disposed on the prosthesis. Although this method provides for an overall volume of coating disposed on the prosthesis it does not provide information regarding the distribution of the coating on the prosthesis or the thickness of the coating.

Thus, there is a need for efficient and accurate methods for determining the distribution of coating(s) along the length of the prosthesis as well as determining the thickness of the coating(s) at any point along the length of the prosthesis.

### SUMMARY OF THE INVENTION

The invention relates to a method of determining the thickness of the coating or coatings applied to the endoprosthesis are disclosed After using any of the techniques described herein to disposed one or more coatings on prosthesis it is desirable to determine the thickness of the coating applied to the prosthesis. Currently, coating thickness is determined by weighing the prosthesis at various times during manufacture. For example, the bare metal prosthesis is initially weighed and the weight is recorded in a log. A first coating process is performed on the prosthesis, thereby depositing a coating along the length of the prosthesis. The prosthesis is then weighed again; the difference in the weights is then utilized to calculate the volume of coating disposed on the prosthesis. A shortcoming of this method is that it only indicates the volume of coating disposed on the prosthesis and not how the coating is distributed along the prosthesis.

The purpose and advantages of embodiments of the invention will be set forth in and will become apparent from the description that follows, as well as will be learned by practice of the invention.

Additional advantages of the invention will be realized and attained by the methods and systems particularly pointed out in the written description and claims hereof as well as from the appended drawings.

Another aspect of the invention, there is provided a method for determining coating thickness of the beneficial agent(s) loaded onto the prosthesis or component of the prosthesis.

It is to be understood that the foregoing general description and the following detailed description are exemplary and explanatory only and are not to be viewed as being restrictive of the invention, as claimed. Further advantages of this invention will be apparent after a review of the following detailed description of the disclosed embodiments which are illustrated schematically in the accompanying drawings and in the appended claims.

### BRIEF DESCRIPTION OF THE DRAWINGS

FIG. 1 is an exemplary embodiment of an endoprosthesis having at least one coating disposed thereon.

FIG. 2 is a functional flow diagram illustrating the method steps for determining coating thickness in accordance with embodiments of the invention.

FIG. 3 is a cross-sectional view of a portion of a prosthesis embedded in epoxy in accordance with the methods of embodiments of the invention.

FIG. 4 is a cross-sectional view of a portion of a prosthesis illustrating the thickness of the coating disposed on the prosthesis, according to embodiments of the invention,

FIG. 5 is an exemplary embodiment of a cross-sectional view of a prosthesis having a coating disposed thereon, wherein a plurality of vectors which are utilized to determine coating thickness in accordance with methods of embodiments of the invention.

FIG. 6 is a functional flow diagram illustrating a process in accordance with an alternative embodiment of the invention.

FIG. 7 is an exemplary embodiment of a white light interferometry device, according to embodiments of the invention.

### DETAILED DESCRIPTION OF THE INVENTION

Reference will now be made in detail to embodiments of the method and system for loading beneficial agent onto a prosthesis, and the interventional devices loaded with beneficial agent. Wherever possible, the same reference characters will be used throughout the drawings to refer to the same or like parts.

In accordance with embodiments of the invention, an interventional device is provided for delivery of beneficial agent within a lumen. Particularly, embodiments of the invention are suited for providing an interventional device having a controlled areal density of beneficial agent for the treatment and prevention of vascular or other intraluminal diseases. Generally, “controlled areal density” is understood to mean a known or predetermined amount of beneficial agent, either by weight or volume, over a unit surface area of the interventional device.

As used herein “interventional device” refers broadly to any device suitable for intraluminal delivery or implantation. For purposes of illustration and not limitation, examples of such interventional devices include stents, grafts, stent-grafts, filters, and the like. As is known in the art such devices may comprise one or more prostheses, each having a first cross-sectional dimension or profile for the purpose of delivery and a second cross-sectional dimension or profile after deployment Each prosthesis may be deployed by known mechanical techniques including balloon expansion deployment techniques, or by electrical or thermal actuation, or self-expansion deployment techniques, as well known in the art. Examples of such for purpose of illustration include U.S. Pat. No. 4,733,665 to Palmaz; U.S. Pat. No. 6,106,548 to Roubin et al.; U.S. Pat. No. 4,580,568 to Gianturco; U.S. Pat. No. 5,755,771 to Penn et al.; and U.S. Pat. No. 6,033,434 to Borghi, all of which are incorporated herein by reference.

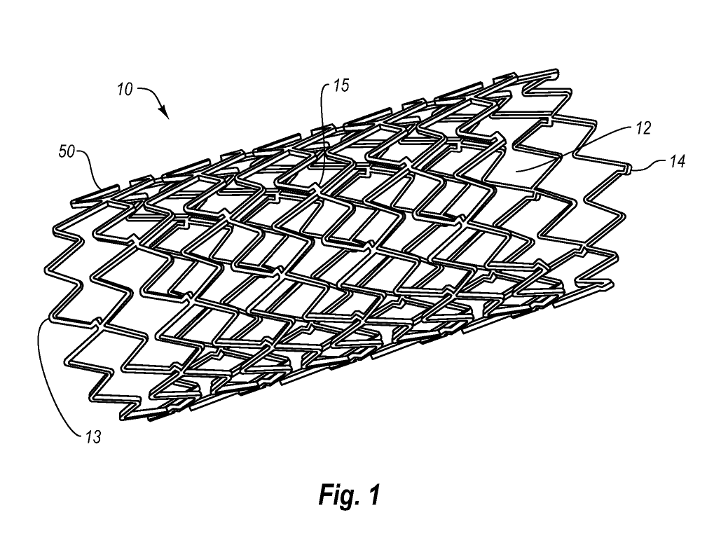

For purposes of explanation and illustration, and not limitation, an exemplary embodiment of the interventional device in accordance with the invention is shown in FIG. 1. In accordance with one aspect of the invention, as shown in FIG. 1, the interventional device generally includes a prosthesis 10 loaded with beneficial agent to provide a local areal density of beneficial agent across a length of the interventional device. Particularly, as embodied herein the prosthesis may be a stent, a graft, a stent-graft, a filter, or the like, as previously noted, for intravascular or coronary delivery and/or implantation. However, the prosthesis may be any type of intraluminal member capable of being loaded with beneficial agent.

The prosthesis can be in an expanded or unexpanded state during the loading of beneficial agent. The underlying structure of the prosthesis can be virtually any structural design and the prosthesis can be composed any suitable material including, but not limited to, stainless steel, “MP35N,” “MP20N,” elastinite (Nitinol), tantalum, nickel-titanium alloy, platinum-iridium alloy, gold, magnesium, polymer, ceramic, tissue, or combinations thereof “MP35N” and “MP20N” are understood to be trade names for alloys of cobalt, nickel, chromium and molybdenum available from Standard Press Steel Co., Jenkintown, Pa. “MP35N” consists of 35% cobalt, 35% nickel, 20% chromium, and 10% molybdenum, “MP20N” consists of 50% cobalt, 20% nickel, 20% chromium and 10% molybdenum. The prosthesis can be made from bioabsorbable or biostable polymers.

The prosthesis can be fabricated utilizing any number of methods known in the art. For example, the prosthesis can be fabricated from a hollow or formed tube that is machined using lasers, electric discharge milling, chemical etching or other known techniques. Alternatively, the prosthesis can be fabricated from a sheet that is rolled into a tubular member, or formed of a wire or filament construction as known in the art.

As noted above, the prosthesis is at least partially loaded with beneficial agent (10a, 10b, 10c). “Beneficial agent” as used herein, refers to any compound, mixture of compounds, or composition of matter consisting of a compound, which produces a beneficial or useful result. The beneficial agent can be a polymer, a marker, including a radiopaque dye or particles, or can be a drug, including pharmaceutical and therapeutic agents, or an agent including inorganic or organic drugs without limitation. The agent or drug can be in various forms including uncharged molecules, components of molecular complexes, pharmacologically-acceptable salts including hydrochloride, hydrobromide, sulfate, laurate, palmitate, phosphate, nitrate, borate, acetate, maleate, tartrate, oleate, and salicylate.

An agent or drug that is water insoluble can be used in a form that is a water-soluble derivative thereof to effectively serve as a solute, and on its release from the device, is converted by enzymes, hydrolyzed by body pH, or metabolic processes to a biologically active form. Additionally, the agents or drug formulations can have various known forms including solutions, dispersions, pastes, particles, granules, emulsions, suspensions and powders. The drug or agent may or may not be mixed with polymer or a solvent as desired.

For purposes of illustration and not limitation, the drug or agent can include antithrombotics, anticoagulants, antiplatelet agents, thrombolytics, antiproliferatives, anti-inflammatories, agents that inhibit hyperplasia, inhibitors of smooth muscle proliferation, antibiotics, growth factor inhibitors, or cell adhesion inhibitors. Other drugs or agents include but are not limited to antineoplastics, antimitotics, antifibrins, antioxidants, agents that promote endothelial cell recovery, antiallergic substances, radiopaque agents, viral vectors, antisense compounds, oligionucleotides, cell permeation enhancers, angiogenesis agents, and combinations thereof.

Examples of such antithrombotics, anticoagulants, antiplatelet agents, and thrombolytics include sodium heparin, low molecular weight heparins, heparinoids, hirudin, argatroban, forskolin, vapriprost, prostacyclin and prostacylin analogues, dextran, D-phe-pro-arg-chloromethylketone (synthetic antithrombin), dipyridamole, glycoprotein IIb/IIIa (platelet membrane receptor antagonist antibody), recombinant hirudin, and thrombin inhibitors including Angiomax™, from Biogen, Inc., Cambridge, Mass.; and thrombolytic agents, including urokinase, e.g., Abbokinase™ from Abbott Laboratories Inc., North Chicago, Ill., recombinant urokinase and pro-urokinase from Abbott Laboratories Inc., tissue plasminogen activator (Alteplase™ from Genentech, South San Francisco, Calif. and tenecteplase (TNK-tPA). 31 Examples of such cytostatic or antiproliferative agents include rapamycin and its analogs including everolimus, ABT-578, i.e., 3S,6R,7E,9R,10R,12R,14S,15E,17E,19E,21S,23S, 26R,27R,34aS)-9,10,12,13,14,21,22,23,24,25,26,27,32,33,34,34a-Hexadecahydro-9,27-dihydroxy-3-[(1R)-2-[(1S,3R,4R)-3-methoxy-4-tetrazol-1-yl)cyclohexyl]-1-methylethyl]-10,21-dimethoxy-6,8,12,14,20,26-hexamethyl-23,27-epoxy-3H-pyrido[2,1-c][1,4]oxaazacyclohentriacontine-1,5,11,28,29(4H,6H,31H)-pentone;23,27-Epoxy-3H pyrido[2,1-c][1,4]oxaazacyclohentriacontine-1,5,11,28,29(4H,6H,31H)-pentone, which is disclosed in U.S. Pat. No. 6,015,815, U.S. Pat. No. 6,329,386, US Publication 2003/129215, filed on Sep. 6, 2002, and US Publication 2002/123505, filed Sep. 10, 2001, the disclosures of which are each incorporated herein by reference thereto, tacrolimus and pimecrolimus, angiopeptin, angiotensin converting enzyme inhibitors including captopril, e.g, Capoten® and Capozide® from Bristol-Myers Squibb Co., Stamford, Conn., cilazapril or lisinopril, e.g., Prinivil® and Prinzide® from Merck & Co., Inc., Whitebouse Station, N.J.; calcium channel blockers including nifedipine, amlodipine, cilnidipine, lercanidipine, benidipine, trifluperazine, diltiazem and verapamil, fibroblast growth factor antagonists, fish oil (omega 3-fatty acid), histamine antagonists, lovastatin, e.g. Mevacor® from Merck & Co., Inc., Whitehouse Station, N.J. In addition, topoisornerase inhibitors including etoposide and topotecan, as well as antiestrogens including tamoxifen may be used.

Examples of such anti-inflammatories include colchicine and glucocorticoids including betamethasone, cortisone, dexamethasone, budesonide, prednisolone, methylprednisolone and hydrocortisone. Non-steroidal anti-inflammatory agents include flurbiprofen, ibuprofen, ketoprofen, fenoprofen, naproxen, diclofenac, diflunisal, acetominophen, indomethacin, sulindac, etodolac, diclofenac, ketorolac, meclofenamic acid, piroxicam and phenylbutazone.

Examples of antineoplastics include, but not limited to allating agents including altretamine, bendamucine, carboplatin, carmustine, cisplatin, cyclophosphamide, fotemustine, ifosfamide, lomustine, nimustine, prednimustine, and treosulfin, antimitotics including vincristine, vinblastine, paclitaxel, e.g., TAXOL® by Bristol-Myers Squibb Co., Stamford, Conn., docetaxel, e.g., Taxotere® from Aventis S. A., Frankfort, Germany, antimetabolites including methotrexate, mercaptopurine, pentostatin, trimetrexate, gemcitabine, azathioprine, and fluorouracil, and antibiotics including doxorubicin hydrochloride, e.g., Adriamycin® from Pharmacia & Upjohn, Peapack, N.J., and mitomycin, e.g., Mutamycin® from Bristol-Myers Squibb Co., Stamford, Conn., agents that promote endothelial cell recovery including Estradiol.

Additional drugs which may be utilized in this application include dexamethasone; fenofibrate; inhibitors of tyrosine kinase including RPR-01511A; PPAR-alpha agonists including Tricor™ formulation from Abbott Laboratories Inc., North Chicago, Ill.; endothelin receptor antagonists including ABT-627 having general formula C₂₉H₃₈N₂O₆.ClH, and the following structural formula 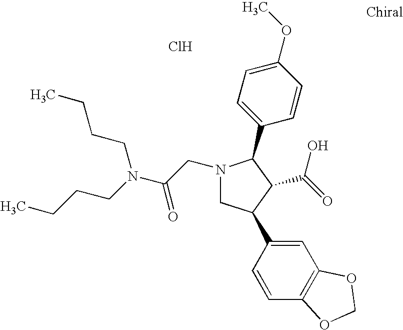
from Abbott Laboratories Inc., North Chicago, Ill., as disclosed in U.S. Pat. No. 5,767,144, the disclosure of which is incorporated herein by reference; matrix metalloproteinase inhibitors including ABT-518 {[S—(R*,R*)]-N-[1-(2,2-dimethyl-1,3-dioxol-4-yl)-2-[[4-[4-(trifluoro-methoxy)-phenoxy]phenyl]sulfonyl]ethyl]-N-hydroxyformamide}, having general formula C₂₁H₂₂F₃NO₈S and having the following structural formula 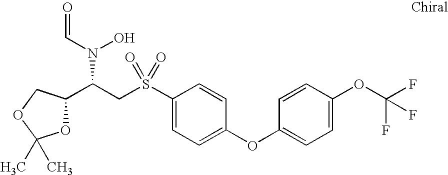
from Abbott Laboratories Inc., North Chicago, Ill., which is disclosed in U.S. Pat. No. 6,235,786, the disclosure of which is incorporated herein by reference; ABT 620 {1-Methyl-N-(3,4,5-trimethoxyphenyl)-1H-indole-5-sulfonamide}, which is disclosed in U.S. Pat. No. 6,521,658, the disclosure of which is incorporated herein by reference; antiallergic agents including permirolast potassium nitroprusside, phosphodiesterase inhibitors, prostaglandin inhibitors, suramin, serotonin blockers, steroids, thioprotease inhibitors, triazolopyrimidine, and nitric oxide,

While the foregoing beneficial agents are known for their preventive and treatment properties, the substances or agents are provided by way of example and are not meant to be limiting. Further, other beneficial agents that are currently available or may be developed are equally applicable for use with embodiments of the invention.

If desired or necessary, the beneficial agent can include a binder to carry, load, or allow sustained release of an agent including, but not limited to, a suitable polymer or similar carrier. The term “polymer” is intended to include a product of a polymerization reaction inclusive of homopolymers, copolymers, terpolymers, etc., whether natural or synthetic, including random, alternating, block, graft, branched, cross-linked, blends, compositions of blends and variations thereof. The polymer may be in true solution, saturated, or suspended as particles or supersaturated in the beneficial agent. The polymer can be biocompatible, or biodegradable.

For purpose of illustration and not limitation, the polymeric material include phosphorylcholine linked macromolecules, including a macromolecule containing pendant phosphorylcholine groups including poly(MPC_{w}:LMAₓ:HPMA_{y}:TSMA_{z}), where MPC is 2-methacryoyloxyethylphosphorylcholine, LMA is lauryl methacrylate, HPMA is hydroxypropyl methacrylate and TSMA is trimethoxysilylpropyl methacrylate, polycaprolactone, poly-D,L-lactic acid, poly-L-lactic acid, polytlactide-co-glycolide), poly(hydroxybutyrate), polyfhydroxybutyrate-co-valerate), polydioxanone, polyorthoester, polyanhydride, poly(glycolic acid), poly(glycolic acid-co-trimethylene carbonate), polyphosphoester, polyphosphoester urethane, poly(amino acids), cyanoacrylates, poly(trimethylene carbonate), poly(iminocarbonate), polyalkylene oxalates, polyphosphazenes, polyiminocarbonates, and aliphatic polycarbonates, fibrin, fibrinogen, cellulose, starch, collagen, Parylene®, Parylast®, polyurethane including polycarbonate urethanes, polyethylene, polyethylene terapthalate, ethylene vinyl acetate, ethylene vinyl alcohol, silicone including polysiloxanes and substituted polysiloxanes, polyethylene oxide, polybutylene terepthalate-co-PEG, PCL-co-PEG, PLA-co-PEG, polyacrylates, polyvinyl pyrrolidone, polyacrylamide, and combinations thereof Non-limiting examples of other suitable polymers include thermoplastic elastomers in general, polyolefin elastomers, EPDM rubbers and polyamide elastomers, and biostable plastic material including acrylic polymers, and its derivatives, nylon, polyesters and expoxies. In embodiments, the polymer contains pendant phosphoryl groups as disclosed in U.S. Pat. Nos. 5,705,583 and 6,090,901 to Bowers et al. and U.S. Pat. No. 6,083,257 to Taylor et al., which are all incorporated herein by reference.

The beneficial agent can include a solvent. The solvent can be any single solvent or a combination of solvents. For purpose of illustration and not limitation, examples of suitable solvents include water, aliphatic hydrocarbons, aromatic hydrocarbons, alcohols, ketones, dimethyl sulfoxide, tetrahydrofuran, dihydrofiran, dimethylacetamide, acetates, and combinations thereof. In embodiments, the solvent is ethanol. In another embodiment, the solvent is isobutanol. Additionally, in another aspect of the invention, multiple beneficial agents are dissolved or dispersed in the same solvent. For purpose of illustration and not for limitation, dexamethasone, estradiol, and paclitaxel are dissolved in isobutanol. Alternatively, dexamethasone, estradiol, and paclitaxel are dissolved in ethanol. In yet another example, dexamethasone, estradiol, and ABT-578, i.e., the rapamycin analog, 3S,6R,7E,9R,10R,12R,14S,15E,17E,19E,21S, 23S,26R,27R,34aS) 9,10,12,13,14,21,22,23,24,25,26,27,32,33,34,34a-Hexadecahydro-9,27-dihydroxy-3-[(1R)-2-[(1S,3R,4R)-3-methoxy-4-tetrazol-1-yl)cyclohexyl]-1-methylethyl]-10,21-dimethoxy-6,8,12,14,20,26-hexamethyl-23,27-epoxy-3H-pyrido[2,1-c][1,4] oxaazacyclohentriacontine-1,5,11,28,29(4H,6H,31H)-pentone; 23,27-Epoxy-3H-pyrido[2,1-c][1,4] oxaazacyclohentriacontine-1,5,11,28,29(4,6H,31H)-pentone, are dissolved together in one solvent. In embodiments, the solvent is ethanol. In other embodiments, the solvent is isobutanol.

Additionally, the beneficial agent includes any of the aforementioned drugs, agents, polymers, and solvents either alone or in combination.

A number of methods can be used to load the beneficial agent onto the surface of the prosthesis to provide for a controlled local areal density of beneficial agent if performed appropriately. For example, the prosthesis can be constructed to include pores or reservoirs which are impregnated or filled with beneficial agent or multiple beneficial agents. The pores can be sized or spaced apart to correspond to or limit the amount of beneficial agent contained therein in accordance with the desired local areal density pattern along the length of the interventional device, wherein larger pores or more dense spacing would be provided in such portions intended to have a greater local areal density. Alternatively, uniform pores sizes can be provided but the amount of beneficial agent loaded therein is limited accordingly. Additionally, if desired, a membrane of biocompatible material can then be applied over the pores or reservoirs for sustained or controlled release of the beneficial agent from the pores or reservoirs.

According to some of the embodiments, the beneficial agent can be loaded directly onto the prosthesis or alternatively, the beneficial agent is loaded onto a base material layer that is applied to a surface of the prosthesis. For example and not limitation, a base coating, including a binder or suitable polymer, is applied to a selected surface of the prosthesis such that a desired pattern is formed on the prosthesis surface. Beneficial agent is then applied directly to the pattern of the base material.

A suitable base coating capable of retaining beneficial agent therein can be applied uniformly over the surface or component of the prosthesis, and then selected portions of the base coating can be loaded with the beneficial agent in accordance with the invention.

In any of the embodiments disclosed herein, a porous or biodegradable membrane or layer made of biocompatible material can be coated over the beneficial agent for sustained release thereof, if desired.

Conventional coating techniques can be utilized to coat the beneficial agent onto the surface of the prosthesis including spraying, dipping or sputtering and still provide the desired effect if performed appropriately. With such techniques, it may be desirable or necessary to use known masking or extraction techniques to control the location and amount in which beneficial agent is loaded. Prior to coating the prosthesis with beneficial agent, optical machine vision inspection of the prosthesis, in embodiments, is utilized to ensure that no mechanical defects exist. Defective prostheses thus can be rejected before wasting beneficial agent, some of which may be very costly.

The beneficial agent may also be “printed” onto the surface of the prosthesis by a fluid-dispenser having a dispensing element capable of dispensing beneficial agent in discrete droplets, wherein each droplet has a controlled trajectory. If desired, printing can be combined with conventional coating techniques including spraying or dipping.

“Fluid-dispenser,” as used herein, refers broadly to any device having a dispensing element capable of dispensing fluid in discrete droplets wherein each droplet has a controlled trajectory. For purposes of illustration and not limitation, examples of such fluid-dispensers include fluid-jetting and similar fluid dispensing technology devices including a drop-on-demand fluid printer and a charge-and-deflect fluid printer. However, other fluid-dispensers capable of forming a fluid jet or capable of dispensing discrete droplets having a controlled trajectory are within the scope of embodiments of the invention. In another embodiment, the fluid-dispenser is a fluid-jet print head. Such equipment is available from MicroFab Technologies of Plano, Tex.

Fluid-jetting and similar technology provides numerous advantages not available with conventional loading techniques. For example, fluid jetting technology can be used to deposit materials, including chemical reagents, in controlled volumes onto a substrate at a controlled location, as disclosed in U.S. Pat. No. 4,877,745 to Hayes et al., incorporated herein by reference.

Fluid jetting can also be used to deposit materials in a reproducible way. Fluid-jet based deposition of materials is data driven, non-contact, and requires no tooling. The “printing” information can be created directly from CAD information and stored digitally in software or hardware. Thus, no masks or screens are required. As an additive process with no chemical waste, fluid-jetting is environmentally friendly. Other advantages include the efficiency of fluid jet printing technology. For example, fluid-jetting can dispense spheres of fluid with diameters of 15-200 um at rates of 1-25,000 per second for single droplets on demand, and up to 1 MHz for continuous droplets. See Cooley et al., “Applications of Ink-Jet Printing Technology to BioMEMS and Microfluidic Systems,” Proc. SPIE Conf. on Microfluidics, (October 2001), incorporated herein by reference.

In accordance with embodiments of the invention there is provided methods for determining coating thickness of medical devices. The methods according to embodiments of the invention comprise the steps of coating the coated medical device with a radiopaque coating, placing the medical device within a microscopic device including a scanning electron microscope (SEM) or a light microscope to capture at least one image of the coated medical device, evaluating the captured image using a computer program to determine the thickness of the coating applied to part of the medical device, component of the medical device, and/or cross-sectional area of the medical device.

As used herein, a coated medical device will generally refer to an endoprosthesis having at least one coating disposed thereon as described in greater detail above. It shall be understood that although the methods described herein are described in relation to an endoprosthesis having a beneficial agent coated thereon, this should not be considered limiting in any manner in that the methods disclosed herein may be applied to other medical devices not disclosed herein without departing from the scope of the invention.

Referring now to FIG. 1 there is shown an exemplary embodiment of an endoprosthesis 10 having a coating 50 disposed thereon. The endoprosthesis 10 is generally constructed of a metallic material. In embodiments, the outer metallic layer includes, but is not limited to, at least one of material chosen from the group consisting of gold, silver, platinum, tantalum, stainless steel, steel, nickel, aluminum, titanium, chromium, palladium, rhodium, and iridium. As shown in FIG. 1, the endoprosthesis is formed having a generally tubular structure with a lumen 12 extending between a first end 13 and a second end 14. A pattern 15 is formed within the wall of the tubular structure, the pattern defines a plurality of strut members. The coating 50 is applied to the endoprosthesis 10 using any of the processes described herein, wherein the coating 50 may comprise one or more layers, wherein one or more of the layers may include a beneficial agent therein.

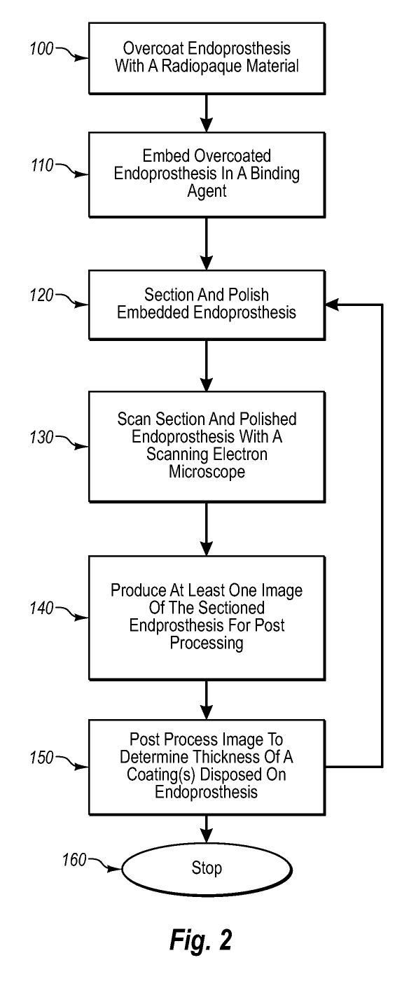

Referring now to FIG. 2 there is shown a functional flow diagram illustrating a method for determining coating thickness of the coating 50 of the endoprosthesis 10.

Referring now to Box 100, the endoprosthesis 10 is overcoated with a radiopaque material. The radiopaque material may be a metallic material, a polymer, a composite material or any other type of radiopaque material. Examples of suitable radiopaque materials include gold, silver, platinum, titanium or similar metals. In embodiments, the endoprosthesis is overcoated with platinum. The radiopaque coating may be applied using known techniques including spraying, dipping, sputter coating, vapor deposition or the like. During the coating process, the entire surface area of the endoprosthesis is coated.

At Box 110, the overcoated endoprosthesis is embedded in epoxy or similar materials which may be utilized to encapsulate the overcoated endoprosthesis.

At Box 120, the embedded endoprosthesis is sectioned, thereby producing one or more endoprosthesis portions. The sectioned endoprosthesis is polished using known metallographic methods. In accordance with an alternative process in accordance with embodiments of the invention, the embedded and sectioned endoprosthesis may be subject to an etching process, wherein the beneficial agent or other coating layers would be removed from the sample, thereby leaving the endoprothesis and the overcoat layer embedded within the section sample. The process of removing the beneficial agent and or other coating layers may be done to improve the determination of coating thickness according to the methods of embodiments of the invention.

At Box 130, the sectioned and embedded endoprosthesis is scanned using a scanning electron microscope (SEM) to produce at least one image of the sectioned endoprosthesis. In another embodiment, the SEM is set to backscatter mode thereby illuminating the individual layer of the coated endoprosthesis. In accordance with an alternative embodiment of the invention, the sample may be imaged using a SEM, wherein the SEM is set in secondary electronic imaging mode or any other suitable mode. Further still, although the process is described as using SEM to image the sample, it is contemplated that other imaging technologies may be utilized to produce images for use with the methods of embodiments of the invention. For example, an optical imaging system may be utilized to produce the desired images. In other embodiments, the step of scanning further includes scanning in secondary electron mode.

In an embodiment, at Box 140, the at least one image of the sectioned and polished endoprosthesis is produced; the image is produced as a grayscale image. The image can be produced by the scanning electron microscope, wherein the magnification of the image may be varied according to the desired output. Additionally, in an embodiment, the image is produced while the scanning electron microscope is placed in backscatter mode, thereby producing an image of higher contrast as shown in FIG. 4 which will be described in greater detail below. In accordance with an alternative embodiment of the invention, images other than grayscale images may be produced. For example, it is contemplated that color images, black or white images may be produced in accordance with methods disclosed herein, wherein these images may be utilized to determine coating thickness in accordance with embodiments of the invention.

At Box 150, the image or images or post processed utilizing software configured to evaluate grayscale images. The software is utilized to automatically calculate the thickness of the coating disposed on the endoprosthesis. The software is user controllable, wherein the user may specify specific areas of the endoprosthesis to be evaluated for coating thickness or the coating applied to the entire endoprosthesis may be evaluated.

The process described herein may be repeated any number of times either on the same section of endoprosthesis, wherein the process would return to Box 120, wherein additional sectioned samples of the coated endoprosthesis would be prepared in accordance with the methods of embodiments of the invention.

At Balloon 160, the process is stopped. Although the process described above has been described in detail with regard to specific physical properties and mechanical properties, it shall be understood that the example given above and illustrated in FIG. 2 is exemplary in nature.

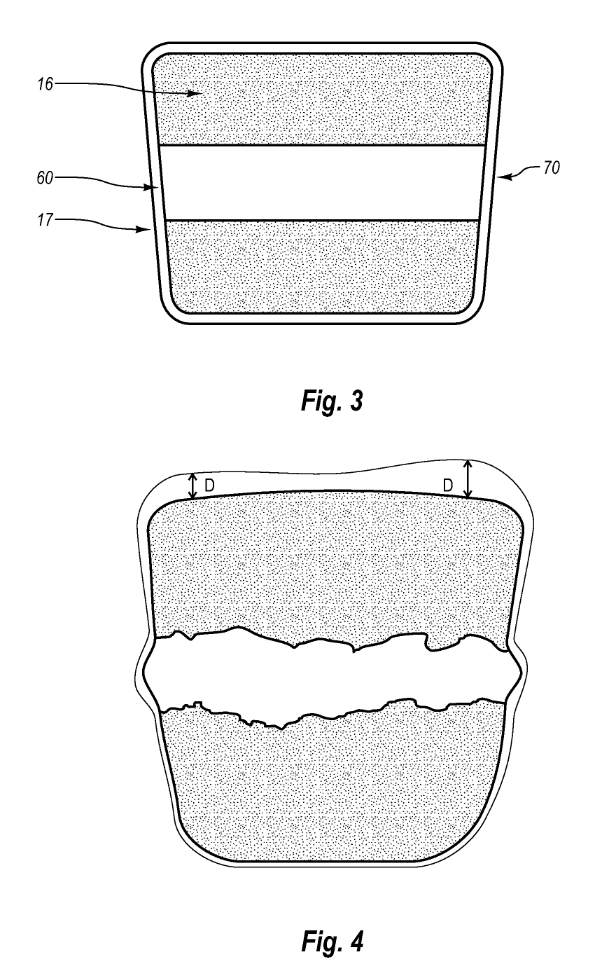

Referring now to FIG. 3, there is shown an exemplary drawing of an image produced according to the process described above, wherein a sectioned endoprosthesis 10 is imaged using a scanning electron microscope. The image shown in FIG. 3 was produced by placing a sample of a sectioned and embedded endoprosthesis into the imaging chamber of a scanning electron microscope. The microscope was then placed into backscatter mode thereby producing the image shown in FIG. 3. The endoprosthesis 10 shown in FIG. 3 is comprised of multiple layers of material. In this instance, the material from which the endoprosthesis has been manufactured of is shown and described in U.S. Pat. No. 5,858,556 to Eckert et al. the entirety of which is hereby incorporated by reference. The exemplary endoprosthesis shown in FIG. 3 includes two layers of stainless steel 16 and a single layer of tantalum 17. Additionally, the endoprosthesis has been coated with one or more coatings 60 as described herein above. Prior to sectioning, embedding or polishing, the endoprosthesis 10 is placed within a chamber and coated with a radiopaque material 70 as described in detail above.

Referring now to FIG. 4, there is shown an exemplary embodiment of an image produced in accordance with the methods of embodiments of the invention. As shown in FIG. 4, the radiopaque coating 70 is clearly highlighted in the image thereby illustrating the outer surface of the coating(s) applied to the endoprosthesis.

As a result of the outer radiopaque coating, the thickness of the coatings) applied to the endoprosthesis can be determined by measuring the distance D between the surface of the endoprosthesis 10, and the outer radiopaque layer 70.

In another embodiment, the image can be analyzed using a computer program to determine the thickness of the coating. By utilizing a computer to analyze the coating disposed on the endoprosthesis, additional data can be generated. For example, it may be desirable to measure the thickness of the coating disposed on the outer surface of the endoprosthesis, on the sides of the struts, or on the inner surface of the endoprosthesis. Alternatively, a plurality of measurements may be combined and averaged to determine the average coating thickness. This process may be repeated at any length along the length of the endoprosthesis to determine: coating thickness, coating integrity, coating distribution or similar properties.

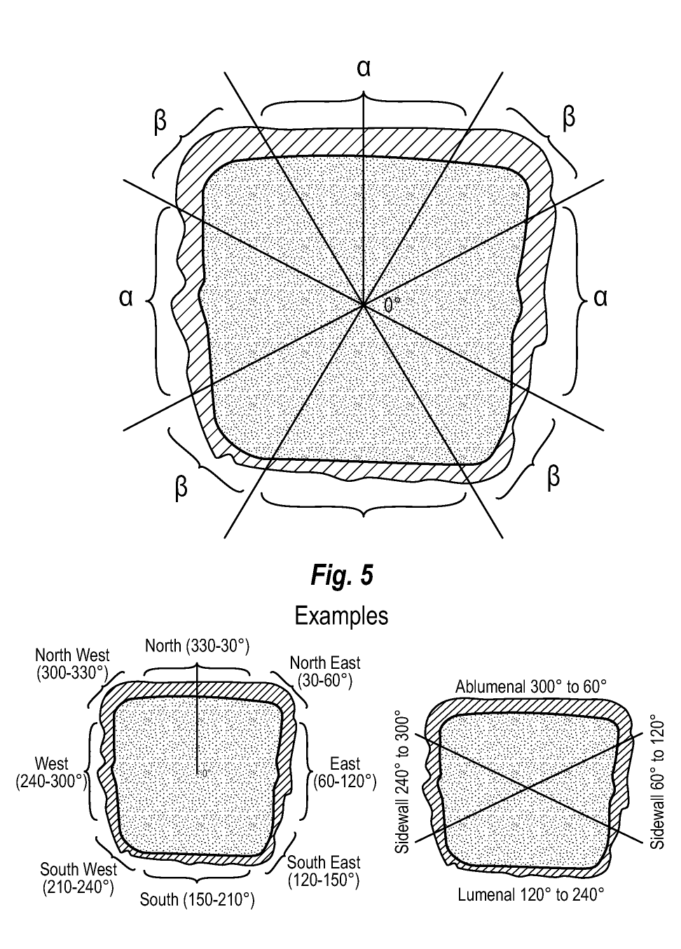

Referring now to FIG. 5, there is shown an exemplary embodiment of an image of a sectioned endoprosthesis produced in accordance with the methods of embodiments of the invention. As shown in FIG. 5, a coordinate system has been overlaid on the image, wherein the sectioned endoprosthesis has been divided into a number of sections. The coating thickness is analyzed in each section by the computer program. The results can be individually reported by section, averaged, segregated into top, bottom and side values, or reported in any manner desired by the user.

Software suitable for use with the methods in accordance with embodiments of the invention includes any software program that utilizes grayscale imaging or color imaging (RGB imaging) including, but not limited to Image-Pro and, SIMAGIS®. The software utilized in accordance with embodiments of the invention utilizes grayscale imaging to automatically calculate the thickness of one or more coatings disposed on an endoprosthesis. As previously described, it is contemplated that the software may be modified to be utilized to analyze medical devices other than those disclosed herein. Further still, the software may be modified to enable the use of other images including black and white images. Additionally, a physical image does not need to be produced for use with embodiments of the invention, digital or analog data may be produced during the scanning process, wherein the data is outputted in a computer readable format which can then be read and utilized by the software to conduct the methods in accordance with embodiments of the invention.

In addition to the methods described herein for determining coating thickness, the methods in accordance with embodiments of the invention may be further adapted or utilized to determine coating integrity along the length of or around the circumference of a coated endoprosthesis. This may be desirable for quality control and or research and development of new coating methods.

Further still in accordance with embodiments of the invention, there is disclosed yet another alternative method for determining the thickness of a coating disposed on a medical device. In accordance with the alternative embodiment, the thickness of the coating may be determined utilizing non-destructive methods. In contrast to the methods disclosed above, the alternative methods according to embodiments of the invention may be utilized to non-destinctively test coating thickness and/or integrity, and therefore may be more useful for production quality control of finished product.

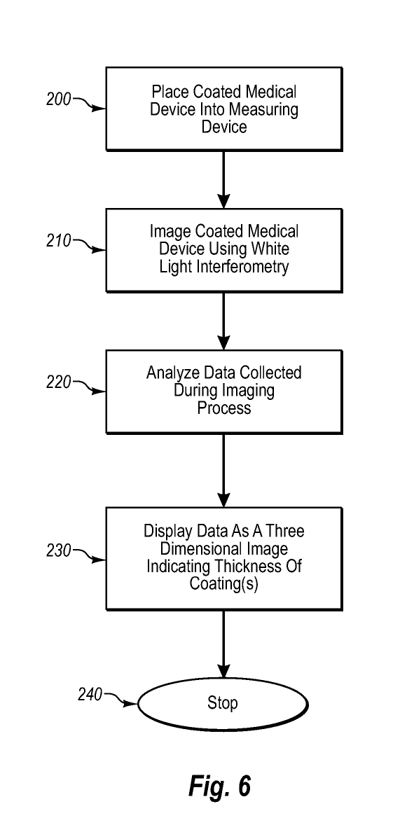

The methods according to the alternative embodiment utilize white light interferometry to determine coating thickness. Referring now to FIG. 6, there is shown a functional flow diagram illustrating the methods according to the alternative embodiment of embodiments of the invention.

At Box 200, a medical device, including an endoprosthesis, having been coated with at least one coating is placed upon or within a measuring platform.

At Box 210, the coated endoprosthesis is imaged using white light interferometry to produce an image of the coated endoprosthesis.

At Box 220, data collected from the imaging process at box 210 is analyzed to determine surface height of the item being imaged.

At Box 230, the processed data is displayed on a display device, wherein the surface or surfaces of the medical device are shown as a three dimensional image. The processed data is further outputted in a machine readable format for further use by other computer programs.

At Balloon 240, the process is stopped and the system is reset for imaging of another medical device.

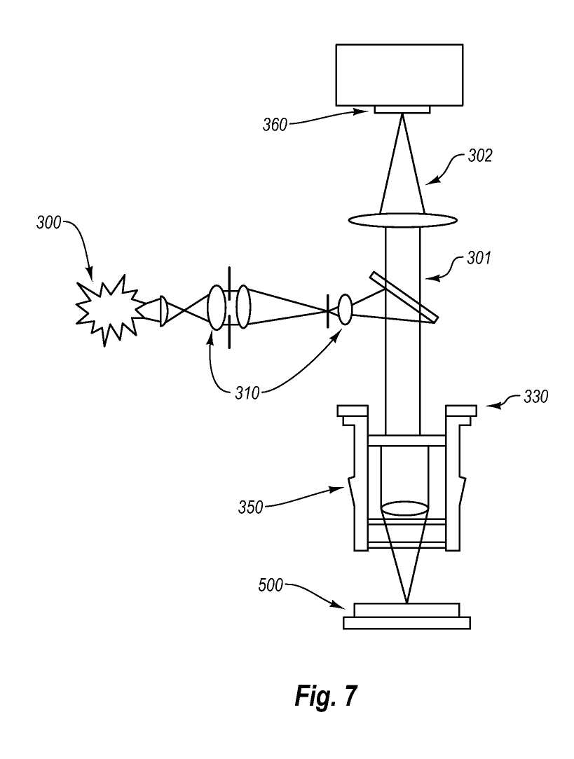

Referring now to FIG. 7 there is shown an exemplary schematic of an interference microscope setup. Suitable examples of such a system is available from Veeco Instruments Inc., model number Wyko NT 1000 including compatible software including Wyco Vision32. As shown in FIG. 7, the interference microscope includes an illumination source 300 which is passed through a series of elements and/or filters 310, the light beam then is passed through to a beam splitter 320, wherein one portion of the beam 301 is directed through a translator 330, a microscope objective 340, a mirau interferometer 350. The light beam then passes onto the surface of the sample 500 to be imaged. A second beam 302 emerges from the beam splitter 320 and is directed through a detector array 360.

In use, the beam of light 301 directed toward the sample 500 is reflected off of the sample 500 and passes to the detector array 360. The reflected beams recombine to form a pattern of interference fringes that is light and dark bands that connect points or surfaces of equal height.

The optical system is translated vertically thereby allowing a series of interference patterns to be captured. The pluralities of interference patterns are analyzed by software to determine the surface height at each location.

In accordance with the process described above, the process may be utilized to determine coating thickness on a coated medical device including an endoprosthesis without having to perform destructive testing in accordance with the previous process described herein. Further still, the alternative process may be utilized to determine coating thickness applied to the exterior, interior, or sidewalls of a medical device including an endoprosthesis.

As described above, the process produces multiple images, which are then combined to form an image of the thickness of coating applied to the medical device. As desired, the user can then manipulate the image. For example, the user may output a three dimensional image of the medical device illustrating the thickness along the length of or along a portion of the medical device. Alternatively, the thickness of the coating may be displayed as a graph, two-dimensional image or any other desired output.

The software algorithm can also be used to measure the thickness of structures, or lining on structures by imaging cross-sections of the structures and importing them into the software and proceeding in a similar manner. The step of applying an algorithm includes measuring the area of the cross-sectional surface and the distance from the surface to the radiopaque layer.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

What is claimed is:

1. A method for determining the thickness of coatings disposed on medical devices, comprising:
disposing an outer radiopaque layer on a medical device or component of a medical device having at least one layer of coating applied thereto;
scanning the medical device with a microscopic device to produce at least one image; and
applying a software program having an algorithm utilizing greyscale imaging or color imaging to determine the thickness of the medical device or component of the medical device having at least one layer of coating applied to the medical device and/or the cross-sectional area of the medical device or component of the medical device.

2. The method according to claim 1, wherein the medical device is an endoprosthesis.

3. The method according to claim 2, further comprising the step of embedding the medical device in a binder, and sectioning the medical device before scanning.

4. The method according to claim 3, wherein the binder is epoxy.

5. The method according to claim 1, wherein the outer radiopaque layer is applied by a method chosen from the group consisting of, vapor deposition, spray coating, dipping, sputter coating.

6. The method according to claim 1, wherein the outer radiopaque later is metallic.

7. The method according to claim 1, wherein the outer metallic layer is comprised of at least one of material chosen from the group consisting of gold, silver, platinum, tantalum, stainless steel, steel, nickel, aluminum, titanium, chromium, palladium, rhodium, and iridium.

8. The method according to claim 1, wherein the step of applying an algorithm comprises measuring the area of the cross-sectional surface and the distance from the surface to the radiopaque layer.

9. The method according to claim 3, further comprising the step of polishing the sectioned medical device.

10. The method according to claim 1, wherein said microscopic device comprises a scanning electron microscope or a light microscope.

11. A method for coating thickness measurements of polymers, comprising:
disposing a radiopaque layer upon a medical device having at least one polymer layer disposed thereon;
embedding the medical device in an epoxy base;
sectioning the medical device;
polishing the sectioned medical device; and
scanning the sectioned medical device with a microscopic device to create an image of the sectioned medical device.

12. The method according to claim 11, wherein the step of scanning further comprises scanning in backscatter mode or secondary electron mode.

13. The method according to claim 11, further including the step of etching away the at least one polymer later.

14. The method according to claim 11, wherein the step of scanning comprises using a scanning electron microscope.

15. The method according to claim 11, wherein the image produced by the scanning step is a grayscale image or color image.

16. The method according to claim 11, wherein said microscopic device comprises a light microscope.
